(19) United States
(12) Patent Application Publication
(10) Pub. No.: US 2006/0007235 A1
(43) Pub. Date: Jan. 12, 2006

(54) Method of accessing frame data and data accessing device thereof

(76) Inventor: Hua-Chang Chi, Yangmei Township (TW)

Correspondence Address: J C PATENTS, INC., 4 VENTURE, SUITE 250, IRVINE, CA, 92618, US

(21) Appl. No.: 10/889,886

(22) Filed: Jul. 12, 2004

(51) Int. Cl. G09G 5/39; G06F 12/00; G06F 12/06

(52) U.S. Cl. 345/531; 711/5

(57) ABSTRACT

A method for accessing frame data and data accessing device thereof are provided to access X-bit frame data. The method comprises providing Y memory banks BANKᵢ (1<Y≦X), where BANKᵢ represents the i^{th} memory bank (0≦i<Y); arranging a partial frame data W_{L,A} (X/Y bits) to be held in BANKⱼ, where W_{L,A} represents a L^{th} line A^{th} frame data word and j=(L+A) mod Y; receiving and according to Y word addresses WAₖ to determine the memory banks where W_{L,A} is located, where addresses WAₖ represent the addresses of the k^{th} partial frame data ((0≦k<Y); and obtaining the partial frame data (X/Y bits) from each BANKᵢ according to the determined results and combining them to form the frame data (X bits).

### BACKGROUND OF THE INVENTION

1. Field of the Invention

The present invention relates to a method of accessing data and data accessing device thereof. More particularly, the present invention relates to a method of accessing frame data and data accessing device thereof.

2. Description of Related Art

In a motion compensation video compression algorithm (for example, MPEG-1, MPEG-2 and MPEG-4), a reference block needs to be captured from a frame according to motion vector. In general, a basic block includes 8*8 or 16*16 pixels. Because the captured units of the motion vector in the horizontal and vertical direction may be half a pixel size greater than the pixel and the horizontal line, the number of captured units in a reference block is 9*9 or 17*17 pixels. FIG. 1 shows a typical 9*9 reference block (for example, enclosed by a dash line frame 110) captured by a search window 100. In FIG. 1, Pᵢⱼ represents the i^{th} row and the j^{th} pixel data (8 bits). Since the motion vector may reside in any location within the search window, the reference block 110 normally differs from the basic block boundary (indicated by a thick line frame 120) of the search window.

Assuming a 64-bit memory bus is capable of capturing an entire row within the basic block boundary in each clock cycle. In other words, a total of 8 pixel data within the basic block boundary 120 can be accessed in each clock cycle. However, each row of the reference block 110 covers two basic block boundaries 120. Hence, capturing a 9*9 reference block 110 requires 9*2=18 clock cycles. As shown in FIG. 1, some of the captured data are unnecessary. For example, among the captured pixel data P_{2,0}, P_{2,1}, . . . , P_{2,15} in the first row, only the pixel data P_{2,3}, P_{2,4}, . . . , P_{2,11} are actually required. The same is true for various other rows. Hence, there is a lot of waste in the frequency bandwidth of the memory bus.

### SUMMARY OF THE INVENTION

Accordingly, the present invention is directed to a method for accessing frame data that can save memory access frequency bandwidth and improve overall system performance.

The present invention is directed to a data accessing device capable of not only saving memory access frequency bandwidth and improving overall system performance but also capable of reducing the access of unnecessary data. Hence, the data accessing device can operate at a lower clock frequency resulting in a drop in power consumption.

According an embodiment of the present invention, a method for accessing X-bit frame data is provided. According to an embodiment of the present invention, X is a positive integer. The method comprises providing Y memory banks BANKᵢ, where BANKᵢ represents the i^{th} memory bank. Y is an integral number having a value greater than 1 but smaller than or equal to X and i is an integral number having a value greater than or equal to 0 but smaller than Y. A partial frame data W_{L,A} having X/Y bits is held in BANKⱼ, where W_{L,A} represents a L^{th} row A^{th} partial frame data, L and A are integral number greater than or equal to 0 and j=(L+A) mod Y such that mod is modular arithmetic. Thereafter, according to Y received word addresses WAₖ, the memory banks where partial frame data of W_{L,A} is located are determined. Here, WAₖ represents the address of the k^{th} partial frame data and k is an integral value greater than or equal to 0 but smaller than Y. According to the determined results, the X/Y bits of partial frame data in various memory banks BANKᵢ are obtained. Finally, the X/Y bits of partial frame data can be retrieved from various memory banks BANKᵢ and combined to form the required frame data.

The present invention also provides a data accessing device for outputting an X-bit pre-stored data according to an address signal, where X is a positive integer. The data accessing device comprises a memory controller, Y memory banks and a combining circuit. The memory controller receives the address signal and outputs Y memory bank addresses and a memory bank determination signal. Y is an integer greater than 1 but smaller than or equal to X. All the Y memory banks are coupled to the memory controller such that any memory bank is able to receive a memory bank address and then output X/Y bits of partial pre-stored data. The combining circuit is coupled to the memory controller and various memory banks. According to the memory bank determination signal, the combining circuit switches and combines the received X/Y bits of partial pre-stored data to output the X-bit pre-stored data. The memory controller receives address signals. According to the address signals, the memory controller determines the locations of various partial pre-stored data constituting the desired pre-stored data in the memory banks and then outputs a memory bank determination signal thereafter.

In the present invention, the data (for example, the frame data and search window data) are separated into a plurality of partial data held in different memory banks, so that the requested data can be obtained by combining the partial data outputted from several memory bank simultaneously. Aside from reducing unwanted data access, some memory access frequency bandwidth can also be saved resulting in an improvement in overall system performance. With an improved system performance, the clock frequency for accessing memory can be reduced to lower power consumption.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 shows a typical 9*9 reference block (for example, enclosed by a dash line frame) captured by a search window.

FIG. 2 is a flow diagram showing the steps for accessing frame data according to one embodiment of the present invention.

FIG. 3 is an example showing a search window that uses a data structure having two memory banks according to one embodiment of the present invention.

FIG. 4 is another example showing a search window that uses a data structure having four memory banks according to another embodiment of the present invention.

FIG. 5 is a table for comparing the data access performance between the conventional technique and the one used according to an embodiment of the present invention.

FIG. 6 is a block diagram of a data accessing device according to one embodiment of the present invention.

FIG. 7A is a block diagram of a data accessing device that uses two memory banks according to one embodiment of the present invention.

FIG. 7B is a block diagram of a memory controller used in the data accessing device in FIG. 7A.

FIG. 7C is a circuit diagram of the determination circuit used in the memory controller in FIG. 7B.

FIG. 7D is a circuit diagram of the combining circuit used in the data accessing device in FIG. 7A.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

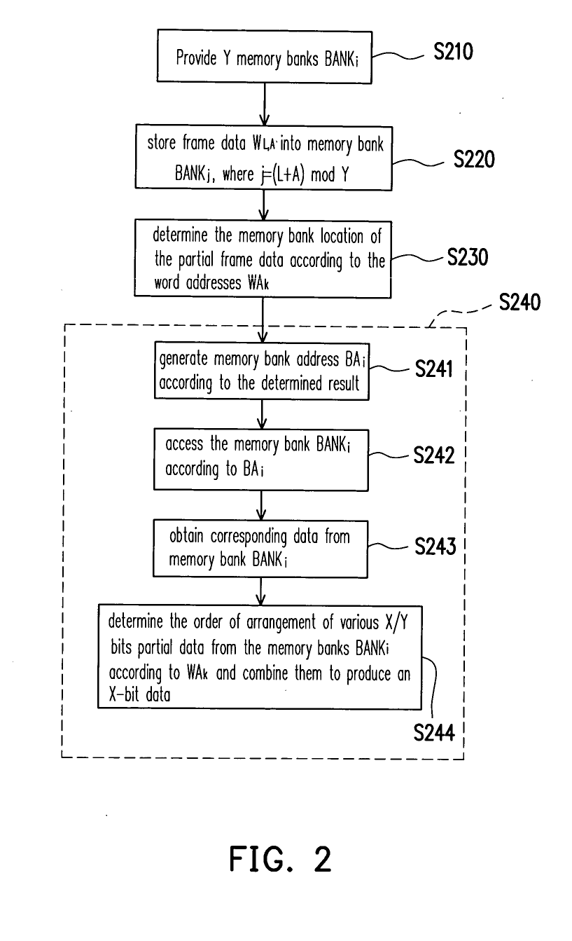

FIG. 2 is a flow diagram showing the steps of accessing frame data according to one embodiment of the present invention. As shown in FIG. 2, the present embodiment is generally used in video processing. In particular, the method is used for obtaining a reference block of frames in video processing so that an X-bit frame data is obtained. Here, X is a positive integer. The method of accessing frame data comprises the following steps. First, in step S210, a total of Y memory banks BANKᵢ is provided. Wherein, BANKᵢ represents the i^{th} memory bank, Y is an integer greater than 1 but smaller than or equal to X, and i is an integer greater than or equal to 0 but smaller than Y. In step S220, a frame data W_{L,A} having X/Y bits is held in BANKⱼ, where W_{L,A} represents a L^{th} row A^{th} partial frame data, L and A are integral numbers greater than or equal to 0 and j=(L+A) mod Y (where mod is modular arithmetic). Thereafter, in step S230, according to Y received word addresses WAₖ, the memory banks where partial frame data of W_{L,A} is located are determined. Here, WAₖ represents the address of the k^{th} partial frame data and k is an integral value greater than or equal to 0 but smaller than Y. In step S240, according to the determined results in step S230, the X/Y bits of partial frame data in various memory banks BANKᵢ are obtained and combined to form the required frame data.

The aforementioned step S240 may include the following sub-steps. In step S241, Y memory bank addresses BAᵢ are produced according to the determined result at step S230, where BAᵢ represents the i^{th} memory bank access address. At step S242, data within memory bank BANKᵢ are accessed according to the memory bank address BAᵢ. At step S243, partial frame data are retrieved from various memory banks BANKᵢ. At step S244, according to the word address WAₖ, the order of partial frame data (X/Y bits) output from various data banks BANKᵢ is determined and then the partial frame data are assembled in order to form the desired frame data (X bits).

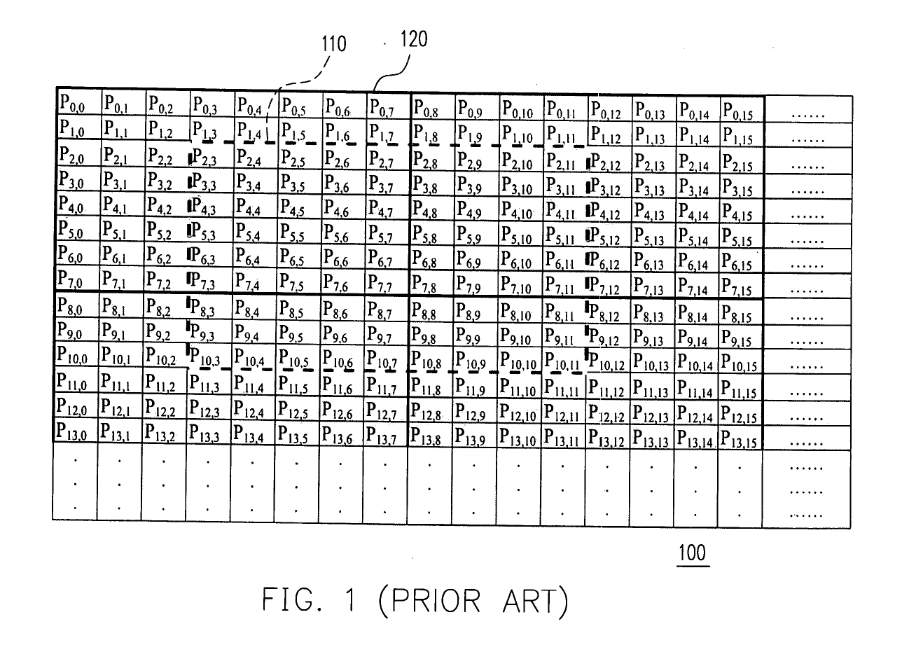

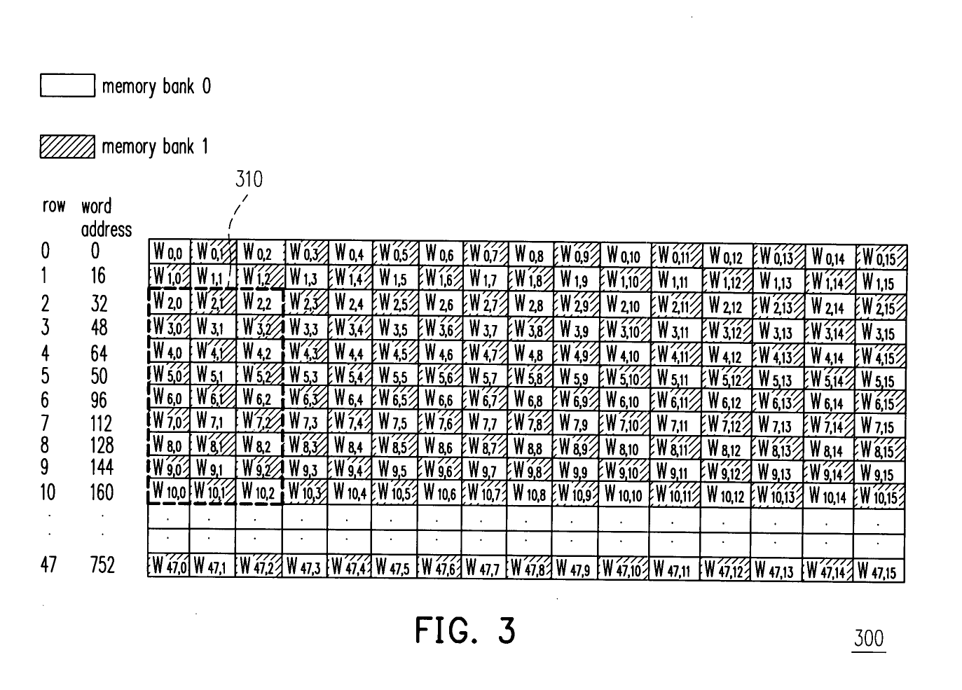

In the aforementioned method, the memory bus of the system assumed to have 64 bits and two memory banks are used to hold frame data. In other words, X is assumed to be 64 and Y is assumed to be 2. Hence, the memory banks each issues a 32 bit partial frame data. FIG. 3 is an example showing a search window that uses a data structure having two memory banks (BANK₀ and BANK₁) according to one embodiment of the present invention. As shown in FIG. 3, the search window 300 is assumed to have a size equal to 64*48 data pixels and Wᵢⱼ is used to represent the i^{th} row and j^{th} partial frame data. In this embodiment, Wᵢⱼ is a 32-bit word comprising 4 pixel data. For example, W_{2,0} includes the pixel data P_{2,0}, P_{2,1}, P_{2,2} and P_{2,3} as shown in FIG. 1. Hence, the reference block 110 in FIG. 1 that needs to be captured is equivalent to the cells within dash-line enclosed block 310 in FIG. 3.

Although two memory banks are used in the present embodiment, the scope of the present invention is not limited as such. If the memory bus has X bits, a total of Y memory banks BANKᵢ can be used. Here, X is a positive integer (typically a power of 2 such as 64 bits) and Y is an integer greater than 1 but smaller than or equal to X (for example, 2, 4 or 8). Also, BANKᵢ represents the i^{th} memory bank and i is an integer greater than or equal to 0 but smaller than Y.

In FIG. 3, neighboring partial frame data Wᵢⱼ and Wᵢⱼ₊₁ are stored in different memory banks. For example, if W_{2,0} is stored in the 0^{th} memory bank BANK₀, then W_{2,1} is stored in the 1^{st} memory bank BANK₁. Similarly, the partial frame data Wᵢⱼ and Wᵢ₊₁ⱼ in the same location of neighboring rows are also stored in different memory banks. For example, if W_{2,0} is stored in memory bank BANK₀, then W_{3,0} is stored in memory bank BANK₁. In other words, the X/Y bits (for example, 32 bits) of partial frame data W_{L,A} is stored in memory bank BANKⱼ, where L and A are integers greater than or equal to 0 and j=(L+A) mod Y. Here, mod is modular arithmetic.

In the conventional technique, a total of 9*2=18 clock cycles is required to capture all the data within the reference block 110 in FIG. 1 if a 64 bit bus is used. According to the present embodiment, only the data within the enclosed block 310 in FIG. 3 needs to be captured. For example, in the first clock cycle, partial frame data W_{2,0} (from BANK₀) and W_{2,1} (from BANK₁) are captured. In the second clock cycle, partial frame data W_{2,2} (from BANK₀) and W_{3,0} (from BANK₁) are captured. In the third clock cycle, partial frame data W_{3,1} (from BANK₀) and W_{3,2} (from BANK₁) are captured and so on. In each clock cycle, a partial frame data is obtained from various memory banks BANKᵢ simultaneously. In the thirteenth clock cycle, partial frame data W_{10,0} (from BANK₀) and W_{10,1} (from BANK₁) are captured. Finally, in the fourteenth clock cycle, partial frame data W_{10,2} (from BANK₀) is captured. In other words, the present embodiment only requires 14 clock cycles to capture all the data within the reference block 110. Hence, the present embodiment eliminates some waste in the memory bus frequency bandwidth and increases reference block accessing efficiency.

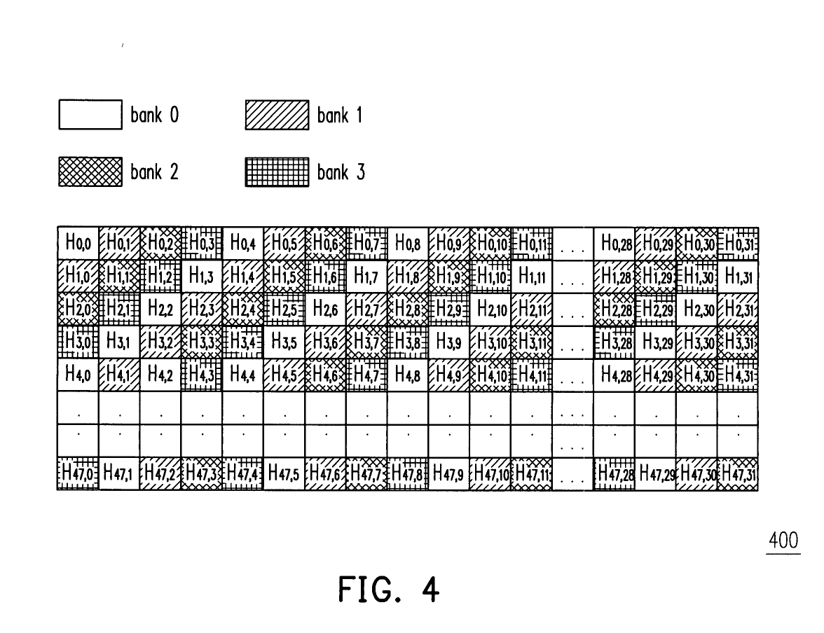

Another embodiment similar to the aforementioned embodiment can be used to illustrate the present invention. In the present embodiment, four memory banks for holding partial frame data are used to output 64-bit data. In other words, X is assumed to be 64 and Y is assumed to be 4. Therefore, each memory bank outputs a 16-bit partial frame data. FIG. 4 is another example showing a search window that uses a data structure having four memory banks (BANK₀ to BANK₃) according to another embodiment of the present invention. As shown in FIG. 4, the search window 400 is assumed to have a size equal to 64*48 data pixels. To distinguish from the 32-bit partial frame data Wᵢⱼ in FIG. 3, Hᵢⱼ is used to represent the i^{th} row and j^{th} partial frame data (16 bits) in FIG. 4. In the present embodiment, Hᵢⱼ comprises 2 pixel data. For example, H_{2,0} comprises pixel data P_{2,0} and P_{2,1} as shown in FIG. 1. The present embodiment only requires 12 clock cycles to capture all the 9*9 reference block data. Since the operation of the present embodiment is identical to the previous one, detailed description is omitted.

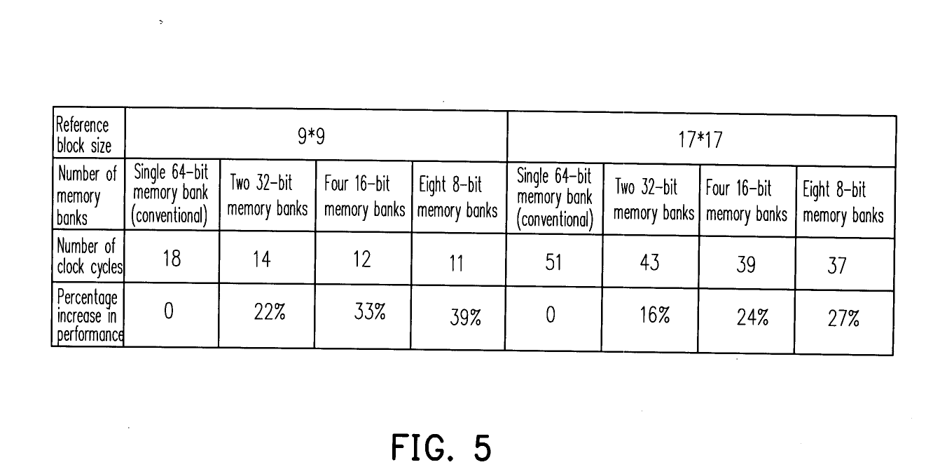

A comparison between the data structure and method of accessing search window data according to the present invention and the ones used conventionally can be made. FIG. 5 is a table showing the comparison data access performance between the conventional technique and the one used according to the present invention. As shown in FIG. 5, the greater the number of memory banks (a smaller data width) deployed, the better will be the data accessing performance.

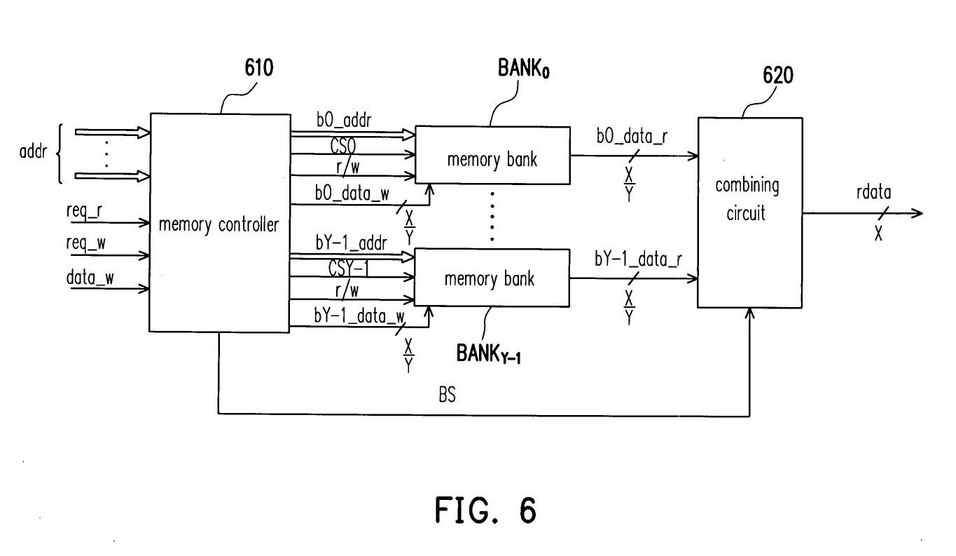

FIG. 6 is a block diagram of a data accessing device according to one embodiment of the present invention. As shown in FIG. 6, the data accessing device mainly serves to output an X-bit pre-stored data (for example, frame data or search window data) rdata according to an address signal addr. A memory controller 610 receives an address signal addr, a read request req_r, a write request req_w and a write data data_w and outputs Y memory bank addresses b0_addr to bY-1_addr, memory bank enable signals CS0 to CSY-1, a read/write control signal r/w, write data b0_data_w to bY-1_data_w and a memory bank determination signal BS. Here, X and Y is defined in a way identical to the aforementioned embodiments.

The memory banks BANK₀ to BANK_{Y-1} are coupled to the memory controller 610. In the present embodiment, the search window data is stored in separate memory banks BANK₀ to BANK_{Y-1} according to the aforementioned data structure. Each memory bank (BANK₀ to BANK_{Y-1} receives a corresponding memory bank address, a memory bank enable signal CS0 to CSY-1, a read/write control signal r/w and write data b0_data_w to bY-1_data_w so that search window data are stored or partial pre-stored data b0_data_r to bY-1_data_r (X/Y bits) are read.

According to the received address signal addr, the memory controller 610 determines the memory bank locations of various partial pre-stored data constituting a particular pre-stored data rdata and outputs a memory bank determination signal BS eventually. A combining circuit 620 is coupled to the memory controller 610 and the memory banks BANK₀ to BANK_{Y-1}. According to memory bank determination signal BS, the combining circuit 620 switches and combines various X/Y bit partial pre-stored data to produce an X-bit pre-stored data rdata (such as a frame data or a search window data in the present embodiment).

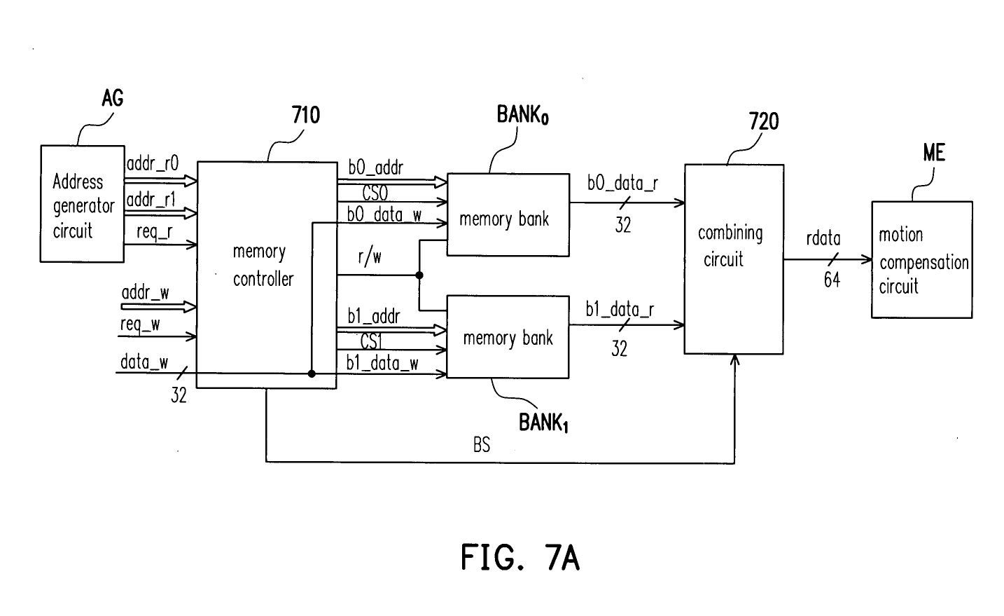

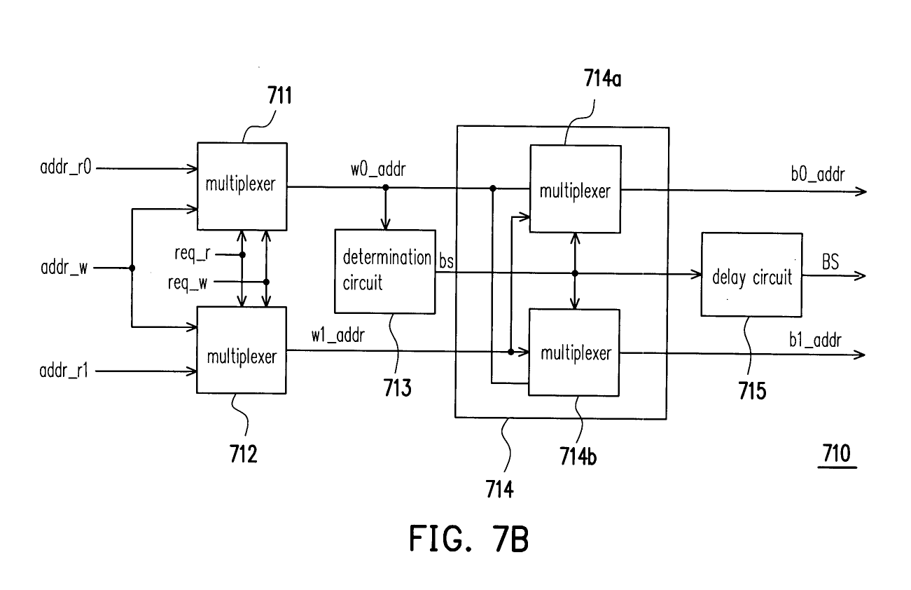

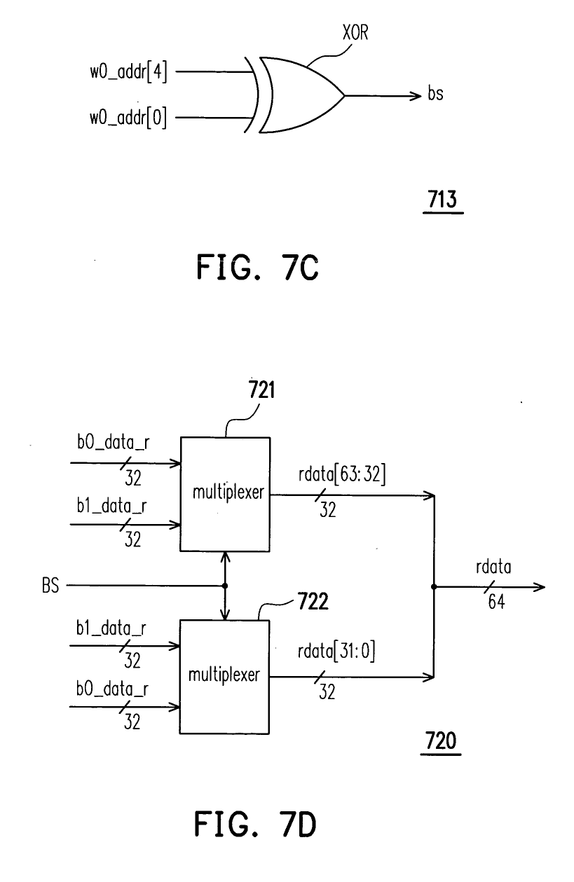

To explain the present invention better, assume a 64-bit pre-stored data rdata is read out through the system memory bus and 2 memory banks are used to hold search window data. In other words, assume X is 64 and Y is 2 in the present embodiment. Hence, each memory bank outputs a 32-bit partial search window data as shown in FIG. 7A. FIG. 7A is a block diagram of a data accessing device that uses two memory banks according to one embodiment of the present invention.

As shown in FIG. 7A, the search window data are separately stored in the memory bank BANK₀ and BANK₁ similar to the data structure in FIG. 3. An address generator (AG) generates the read request req_r signal and the read address signals addr_r0 and addr_r1 to capture a corresponding first word (word 0) and a second word. Through the write request req_w, the write address signal addr_w and the write data data_w, an external circuit refreshes the search window data within the memory banks BANK₀ and BANK₁. In the present embodiment, the read address signals addr_r0 and addr_r1 and the write address signal addr_w have a 10-bit format, for example. The first word, the second word and the write data data_w have a 32-bit format (comprising 4 pixel data if each pixel data has 8 bits), for example.

A memory controller 710 is used for arbitrating between a read request and a write request and generating a read/write control signal r/w, memory bank enable signals CS0 and CS1 and memory addresses b0_addr and b1_addr to the memory banks BANK₀ and BANK₁ respectively. The memory controller 710 also generates a memory bank determination signal BS to indicate the whereabouts of the first word within the memory banks. For example, if BS=0, the first word is located in the memory bank BANK₀. However, if BS=1, the first word is located in the memory bank BANK₁. According to the data structure in FIG. 3, the first word and the second word are captured inside different memory banks. In other words, if the first word is located in the memory bank BANK₀, the second word must be located in the memory bank BANK₁. Conversely, if the first word is located in the memory bank BANK₁, the second word must be located in the memory bank BANK₀. A combining circuit 720 receives the data b0_data_r and b1_data_r (both are 32 bits) output from each memory bank, and switches and combines the data b0_data_r and b1_data_r to form the search window data rdata (64 bits) according to the memory bank determination signal BS. The search window data rdata provides the motion compensation circuit ME of a video processor, for example.

The aforementioned memory controller 710 can be implemented using the device shown in FIG. 7B. FIG. 7B is a block diagram of a memory controller used in the data accessing device in FIG. 7A. As shown in FIG. 7B, the read address signals addr_r0 and addr_r1 and the write address signal addr_w are switched through the multiplexers 711 and 712 (according to the read request req_r and the write request req_w) to generate a first word address w0_addr and a second word address w1_addr respectively. In the present embodiment, the first word address w0_addr is coupled to a determination circuit 713 for producing a memory bank determination signal bs. The first word address w0_addr and the second word address w1_addr are passed to a switching circuit 714. According to the memory bank determination signal bs, the switching circuit 714 switches and output the memory bank addresses b0_addr and b1_addr for memory banks BANK₀ and BANK₁. For example, bs=0 indicates that the first word resides in the memory bank BANK₀, hence the first word address w0_addr is coupled to the memory bank address b0_addr while the second word address w1_addr is coupled to the memory bank address b1_addr. Conversely, bs=1 indicates that the first word resides in the memory bank BANK₁, hence the first word address w0_addr is coupled to the memory bank address b1_addr while the second word address w1_addr is coupled to the memory bank address b0_addr.

The switching circuit 714 comprises, for example, a first multiplexer 714a and a second multiplexer 714b. The first multiplexer 714a selects either the first words address w0_addr or the second word address w1_addr and outputs as the memory bank address b0_addr according to the memory bank determination signal bs. The second multiplexer 714b is similar to the first multiplexer 714a. The only exception is that the second multiplexer 714b selects and outputs the second word address w1_addr to be the memory bank address b1_addr when the first multiplexer 714a selects and outputs the first word address w0_addr to be the memory bank address b0_addr and vice versa. The determination signal bs passes to a buffering delay circuit 715 before emerging as the determination signal BS. Since the memory banks need a few clock cycles (dependent on the conditions in which the memories are deployed) to execute a read instruction and output the required data, the delay circuit 715 is utilized to synchronize with the output from the memory banks.

In the present embodiment, the determination circuit 713 can be implemented using a circuit shown in FIG. 7C. FIG. 7C is a circuit diagram of the determination circuit used in the memory controller in FIG. 7B. As shown in FIGS. 3 and 7C, if both the 0^{th} bit (represented by w0_addr[0]) and the 4^{th} bit (represented by w0_addr[4]) of the word address w0_addr are ‘0’ (or ‘1’), the reference window data (frame data) corresponding to the first word address w0_addr is stored in memory bank BANK₀. On the contrary, if w0_addr[0] and w0_addr[4] are different, the reference window data (frame data) corresponding to the first word address w0_addr is stored in memory bank BANK₁. Therefore, the determination circuit 713 in FIG. 7B can be implemented using exclusive-OR gate XOR.

Furthermore, the combining circuit 720 in FIG. 7A can be implemented as shown in FIG. 7D. FIG. 7D is a circuit diagram of the combining circuit used in the data accessing device in FIG. 7A. As shown in FIG. 7D, rdata[63:32] represents the 32^{nd} to 63^{rd} bit data of the search window data rdata. Similarly, rdata[31:0] represents the 0^{th} to the 31^{st} bit data of the search window data rdata. Thus, a 64-bit search window data rdata for the next circuit (for example, the motion compensation circuit) is provided. The data b0_data_r and b1_data_r (both are 32 bits) output from the memory banks BANK0 and BANK1 in FIG. 7A are connected to the multiplexers 721 and 722. According to the memory bank determination signal BS (generated by the memory controller 710), the multiplexer 721 selects either the data b0_data_r or b1_data_r which is the first word to output as the search window data rdata[63:32]. Similarly, the multiplexer 722 selects either the data b0_data_r or b1_data_r which is the second word to output as the search window data rdata[31:0]. For example, if BS=0, the multiplexer 721 selects and submits the data b0_data_r to the search window data rdata[63:32] while the multiplexer 722 selects and submits the data b1_data_r to the search window data rdata[31:0]. Conversely, if BS=1, the multiplexer 721 selects and submits the data b1_data_r to the search window data rdata[63:32] while the multiplexer 722 selects and submits the data b0_data_r to the search window data rdata[31:0].

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method of accessing frame data, for retrieving an X-bit frame data, where X is a positive integer, comprising the steps of:
providing Y memory banks BANKᵢ, wherein BANKᵢ represents the i^{th} memory bank, Y is an integer greater than 1 and smaller than or equal to X and i is an integer greater than or equal to 0 but smaller than Y;
transferring frame data W_{L,A} into BANKⱼ, wherein W_{L,A} represents the L^{th} row A^{th} partial frame data having X/Y bits, L and A are integers greater than or equal to 0, and j=(L+A) mod Y, wherein mod is modular arithmetic;
determining the memory bank locations of the partial frame data to be read according to Y received word addresses WAₖ, wherein WAₖ represents the address of the k^{th} partial frame data, k is an integer greater than or equal to 0 but smaller than Y; and
retrieving the X/Y bits partial frame data from the memory banks BANKᵢ according to the determined memory bank locations and combining all the partial frame data to form the desired frame data.

2. The method of accessing frame data of claim 1, wherein the step of retrieving the partial frame data further comprises:
generating Y memory bank addresses BAᵢ according to the result of the step of determining the memory bank locations of the partial frame data, wherein BAᵢ represents the access address of the i^{th} memory bank BANKᵢ;
accessing the memory bank BANKᵢ according to the memory bank address BAᵢ;
retrieving corresponding partial frame data from the memory bank BANKᵢ; and
determining the order of arrangement of the X/Y bits partial frame data output from the memory banks BANKᵢ according to the word addresses WAₖ and combining them according to that order to produce the desired X-bit frame data.

3. The frame data accessing method of claim 1, wherein the method is applied to video processing.

4. The method of accessing frame data of claim 3, wherein the method is applied to provide a reference block of frame in video processing.

5. A data accessing device for outputting an X-bit pre-stored data according to an address signal, wherein X is a positive integer, the data accessing device comprising:
a memory controller, for receiving the address signal and outputting Y memory bank addresses and a memory bank determination signal, wherein Y is an integer greater than 1 but smaller than or equal to X;
Y memory banks, coupled to the memory controller such that each memory bank receives a corresponding memory bank address and outputs a corresponding X/Y bits partial pre-stored data; and
a combining circuit, coupled to the memory controller and all the memory banks for receiving the X/Y bits partial pre-stored data and switching and combining them according to the memory bank determination signal to produce the X-bit pre-stored data,
wherein the memory controller determines the memory bank locations holding the partial pre-stored data for reconstituting the pre-stored data according to the address signal and outputs the determined result as the memory bank determination signal.

6. The device of claim 5, wherein the value of Y includes 2.

7. The device of claim 6, wherein the address signal further comprises a first word address and a second word address, and the memory controller further comprising:
a determination circuit, for receiving the first word address, determining the location of the partial pre-stored data within the memory banks accordingly and outputting the memory bank determination signal according to the determined result; and
a switching circuit, for determining the state of coupling between the input and output terminal of the switching circuit according to the memory bank determination signal, wherein the coupling states include coupling the first word address to output a first memory bank address and the second word address to output a second memory bank address or coupling the first word address to output a second memory bank address and the second word address to output a first memory bank address, and the first memory bank address and the second memory bank address are one of the memory bank addresses respectively.

8. The device of claim 7, wherein the determination circuit comprises a exclusive-OR gate, and the exclusive-OR gate receives a portion of the address bits within the first word address and performs an exclusive-OR operation to output the memory bank determination signal.

9. The device of claim 6, wherein the combining circuit determines the order of arrangement of the partial pre-stored data according to the memory bank determination signal and combines the partial pre-stored data to produce the pre-stored data.

10. The device of claim 5, wherein one application of the device comprises processing video data.

11. The device of claim 10, wherein one application of the device comprises accessing frame data.

12. The device of claim 11, wherein one application of the device comprises retrieving a reference block from the frame data.
